(19) United States
(12) Patent Application Publication
(10) Pub. No.: US 2015/0156383 A1
(43) Pub. Date: Jun. 4, 2015

(54) VEHICLE VISION SYSTEM WITH CAMERA HAVING LIQUID LENS OPTIC

(71) Applicant: MAGNA ELECTRONICS INC., Auburn Hills, MI (US)

(72) Inventors: Michael Biemer, Aschaffenburg-Obernau (DE); Pirmin Bader, Burghausen (DE)

(21) Appl. No.: 14/558,981

(22) Filed: Dec. 3, 2014

Related U.S. Application Data
(60) Provisional application No. 61/911,666, filed on Dec. 4, 2013.

(51) Int. Cl. H04N 5/225; G02B 3/14; G02B 26/00; H04N 5/232; B60R 11/04

(52) U.S. Cl. CPC H04N 5/2259; H04N 5/23296; B60R 11/04; G02B 26/004; G02B 3/14; B60R 2011/004

(57) ABSTRACT

A vision system of a vehicle includes a camera disposed at a vehicle and having a field of view. The camera includes an imager and a lens, with the lens having a liquid optic. A control is operable to vary a voltage at the liquid optic to adjust the liquid optic to adjust at least one of (i) a tilt of the lens and (ii) a focal length of the lens. The control is operable to adjust the liquid optic responsive to one of (i) detection of an object, (ii) movement of an object and (iii) a vehicle input. An image processor is operable to process image data captured by the camera.

### CROSS REFERENCE TO RELATED APPLICATION

The present application is related to U.S. provisional application Ser. No. 61/911,666, filed Dec. 4, 2013, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935; and/or 5,550,677, which are hereby incorporated herein by reference in their entireties.

### SUMMARY OF THE INVENTION

The present invention provides a vision system or imaging system for a vehicle that utilizes one or more cameras (preferably one or more CMOS cameras) to capture image data representative of images exterior of the vehicle. The camera has a lens that focuses images at an imaging array or imager of the camera. The lens has at least one liquid or fluid optic element that is adjustable to adjust a tilt and/or focal length of the lens. The liquid optic element is adjustable via a varying applied voltage that is selectively applied at the lens to adjust the liquid optic and lens. For example, a control may vary a voltage at the liquid optic to at least one of (i) adjust a tilt of the lens and (ii) adjust a focal length of the lens. The control may vary the voltage responsive to one of (i) detection of an object, (ii) movement of an object and (iii) a vehicle input. An image processor is operable to process image data captured by the camera.

The vision system may provide communication/data signals, including camera data or captured image data, that may be displayed at a display screen that is viewable by the driver of the vehicle, such as when the driver is backing up the vehicle, and that may be processed and, responsive to such image processing, the system may detect an object at or near the vehicle and in the path of travel of the vehicle, such as when the vehicle is backing up or driving forwardly. The vision system may be operable to display a surround view or bird's eye view of the environment at or around or at least partially surrounding the subject or equipped vehicle, and the displayed image may include a displayed image representation of the subject vehicle.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras in accordance with the present invention;

FIG. 2 is a perspective view of a liquid lens (such as a flo.×2.8/3.35 mm available from Qioptiq Photonics GmbH), which is electronically tunable in focus only;

FIG. 3 is a perspective view of a liquid lens (such as a Baltic 617 AF+OIS liquid lens available from Varioptic), which is electrically tunable in focus and in viewing direction with the working principles as shown in FIGS. 4 and 5;

FIG. 4 is a schematic showing the work principle for tilting of a fluid lens;

FIG. 5 is a schematic showing the work principle for focusing of a fluid lens (bottom row) in comparison to static lenses (top row);

FIG. 6 is a schematic showing the working principles for controlling a fluid lens; and

FIG. 7 is a schematic showing the work principle of ‘structure from focal depths,’ where the distance of an object can be measured by tuning the focal depths until an object is sharp and then reading the focal distance, and since a fluid lens focus is tuned by the applied voltage, the voltage correlates to the tuned distance (the object of interest distance).

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a top down or bird's eye or surround view display and may provide a displayed image that is representative of the subject vehicle, and optionally with the displayed image being customized to at least partially correspond to the actual subject vehicle.

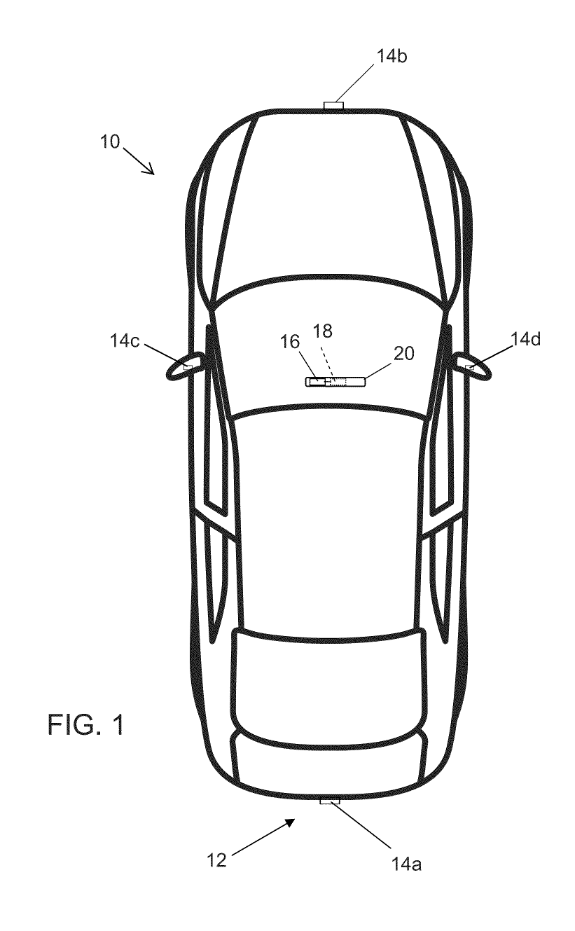

Referring now to the drawings and the illustrative embodiments depicted therein, a vehicle 10 includes an imaging system or vision system 12 that includes at least one exterior facing imaging sensor or camera, such as a rearward facing imaging sensor or camera 14a (and the system may optionally include multiple exterior facing imaging sensors or cameras, such as a forwardly facing camera 14b at the front (or at the windshield) of the vehicle, and a sidewardly/rearwardly facing camera 14c, 14d at respective sides of the vehicle), which captures images exterior of the vehicle, with the camera having a lens for focusing images at or onto an imaging array or imaging plane or imager of the camera (FIG. 1). The vision system 12 includes a control or electronic control unit (ECU) or processor 18 that is operable to process image data captured by the cameras and may provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

Focus cameras typically use lens systems with lens groups that are moved forward and backward when focusing the image onto the imaging plane of the imager or imaging array of the camera. A tilt function is typically impossible with use of just the lens arrangement. In order to tilt the camera's view, the whole camera may be moved, requiring a suitable kinematic function and configuration.

Automotive cameras typically have a fixed focus configuration. Fisheye cameras are per se sharp in all distance ranges, by that these need no focus capability. The resolution of regions in far distances though is often very low, such that use of fish eye lenses on cameras limits the vision systems that require conception of space and objects at far distances.

The present invention provides use of liquid lens optics with focus and tilt capability for a camera of an automotive vision system. Such a liquid lens or adjustable lens may provide new capabilities and possibilities in image conception and processing. The lens and camera and vehicle vision system of the present invention may utilize aspects of the systems and wafer level camera and micromechanic (MEM) or DLP systems described in International Publication No. WO 2013/081985, which is hereby incorporated herein by reference in its entirety.

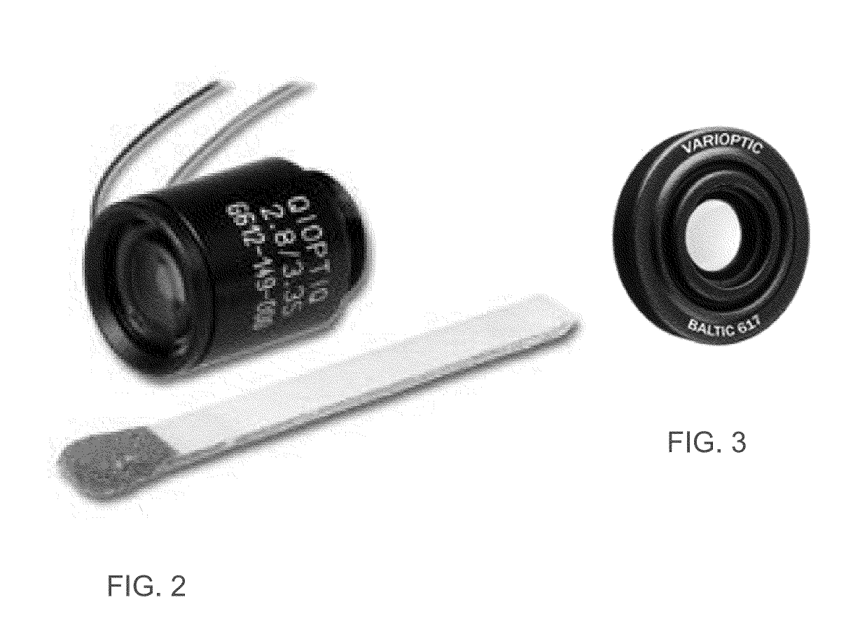

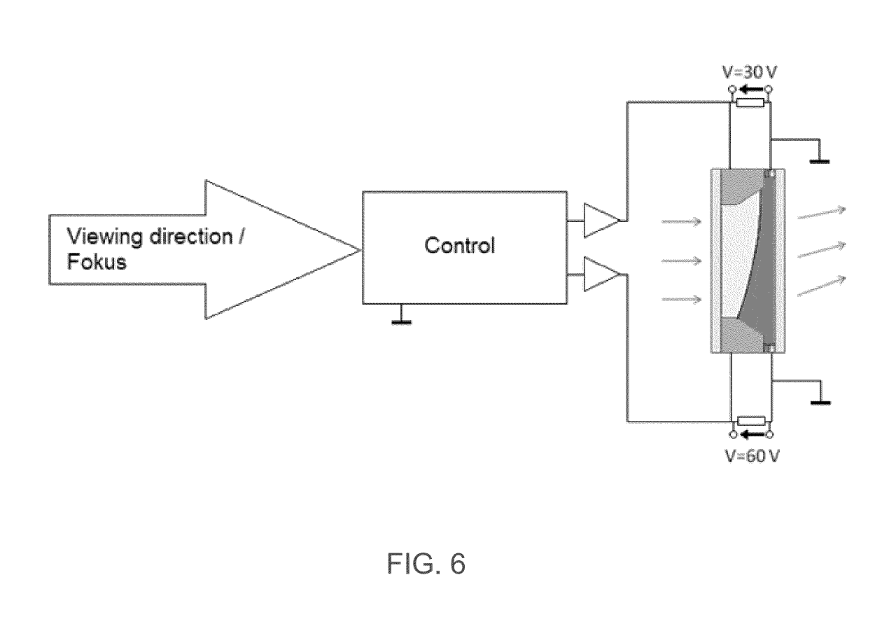

A liquid lens may be tuned or adjusted via a voltage applied to the lens. Alternatively, the control signal may be analog, such as shown in FIG. 6, or a digital coding or a pulse width modulation (PWM) or frequency modulation. The pulse pause or pulse width ratio or frequency may be adjusted to tune an analog voltage level (over time) over the lens tuning capacity. The frequency may be loop controlled in a manner to cope with the liquid lens' frequency response characteristic mostly or at least the lowest response frequency. The lens such as shown, for example, in FIG. 2 may be comparable to a fluid lens available from Qioptiq Photonics GmbH. Such a lens has the following parameters or characteristics: flo.×2.8/3.5; focal length: 3.35 mm; opening 1:2.8; length: 22 mm; diameter: 16 mm; projection diameter: 4 mm for a ¼ inch sensor; and focus capability: 15 mm to infinite.

The lens such as shown, for example, in FIG. 3 may be comparable to a fluid lens Baltic 617 AF+OIS liquid lens from Varioptic. Such a lens is electrically adjustable in yaw and tilt directions and in focus.

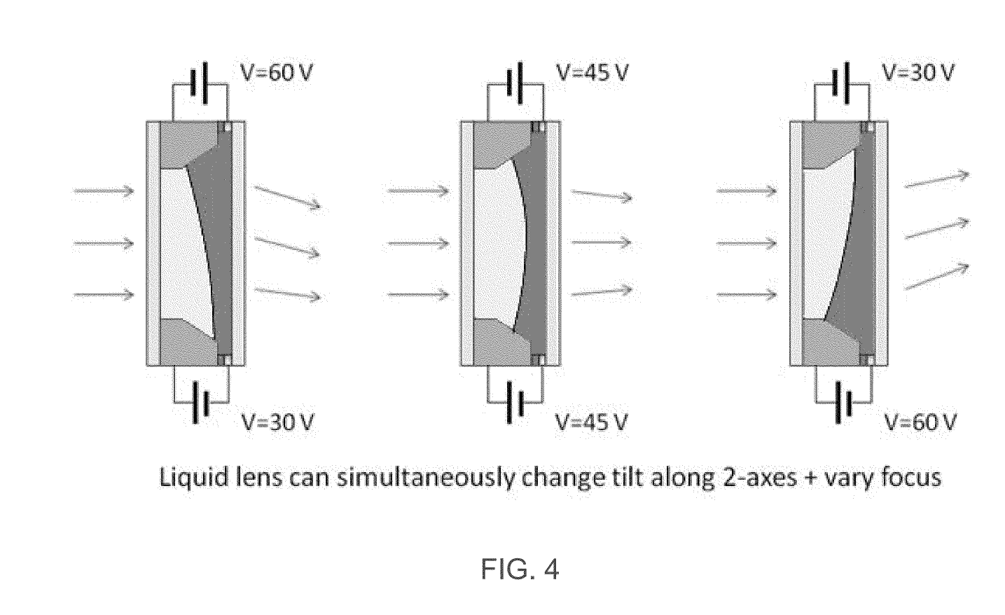

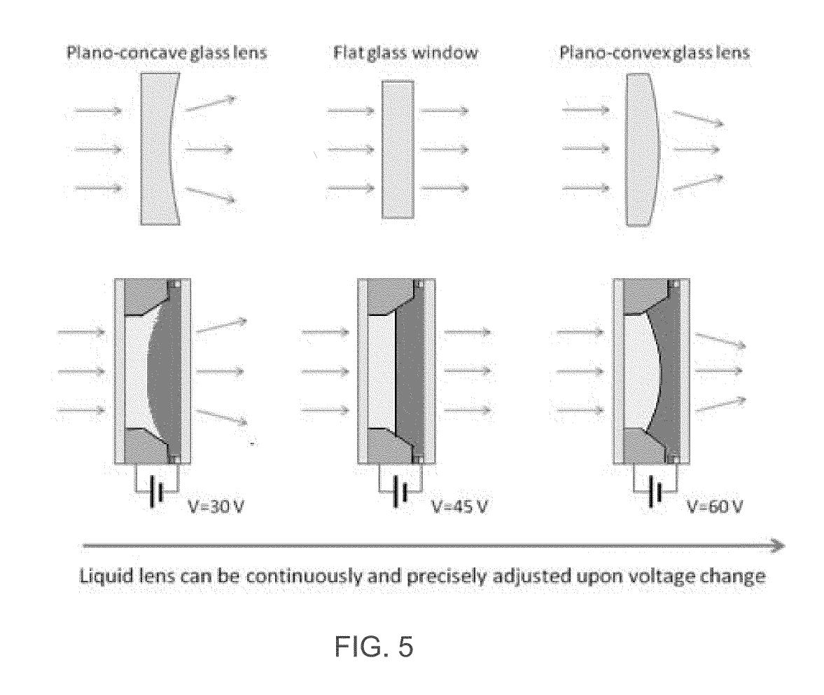

As shown in FIGS. 4 and 5, the liquid lens includes two liquids or fluids with different refraction indexes, such as one liquid or fluid comprising an oil or insulator and the other liquid or fluid comprising a conductor or water or the like. This enables the border of the fluids to bend or curve differently. The fluids are selected to stay fluid (and don't freeze) at temperatures below a selected threshold temperature (such as about −40 degrees C.) or the fluids may be pressurized so that the fluids of the lens stay fluid below a selected threshold temperature.

The liquid lens can change tilt (such as shown, for example, in FIG. 4) and/or can vary the focal length (such as shown, for example, in FIG. 5), with such changes or variations or adjustments or tuning being accomplished via adjusting the applied voltage. For example, and as can be seen with reference to FIG. 4, when the voltage applied at one side of the lens is greater than the voltage applied at the other side of the lens, more of the conductor fluid is drawn towards the greater voltage side, thus effectively tilting the lens optic. Likewise, and as can be seen with reference to FIG. 5, when a greater voltage is applied at the lens, the lens optic may provide a narrower focus lens as compared to reduced applied voltages. The liquid lens thus can be continuously and substantially precisely adjusted to adjust a viewing angle or direction and can change tilt along two axes and can vary the focus of the lens via a change in the voltage applied at the lens.

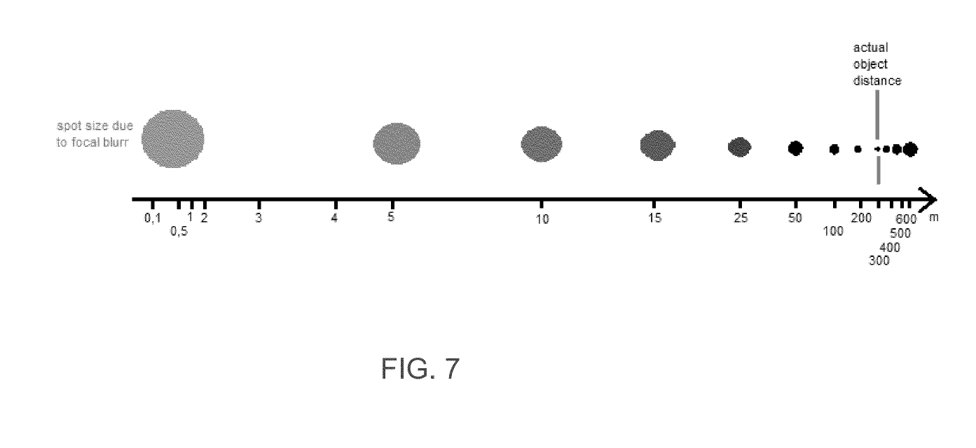

Also, when the tuning ratio versus voltage is known, the focal distance can be read by fetching the voltage of the liquid lens focus at the time an autofocus has sharply focused or tuned an object of interest sharply (such as can be seen with reference to FIG. 7). Thus, the distance of an object from the camera or vehicle can be measured by tuning the focal depths until the object is sharp and then reading the focal distance (such as by reading the applied tuning voltage). Because the fluid lens focus is tuned by the applied voltage, the voltage (as may be read when the object is sharply focused) correlates to the tuned distance (the object of interest distance).

The ability to adjust the focal length may be used as a measure of distance for detecting ‘structure from focus.’ The opening angle may be comparably small, such as, for example, about 15 degrees. By using the tilt capability (pitch and yaw), a wider viewing angle (such as, for example, greater than about 15 degrees) may be scanned (such as about +/−40 degrees). By that the distance of far objects and free space may also be detectable or determinable during covering an acceptable wide viewing window.

This may enable the system to provide a vision only city or even highway mitigation system or vision based redundancy to parallel employed scene detection systems for city or highway mitigation or for detecting the scene behind the vehicle when backing up. By continuously scanning the area in front of the intended path of travel of a vehicle, the system of the present invention may create a topography map and may compute the texture for classifying objects determined to be present in the field of view of the camera or cameras. The classifier may indicate which objects may be traffic participants, which may be on the road, and which objects may be off road, and may indicate traffic signs, traffic lights and lane markings and/or the like. By watching the objects' distance (relative to the vehicle or camera or sensor) over time, their way of travel may be detectable. The system then may employ known collision and conflict avoidance systems (such as by utilizing aspects of the systems described in U.S. patent application Ser. No. 14/016,790, filed Sep. 3, 2013 (Attorney Docket MAG04 P-2139), and/or and U.S. provisional applications, Ser. No. 62/075,349, filed Nov. 5, 2014, which are hereby incorporated herein by reference in their entireties).

The scanning capabilities may additionally enable light detecting and ranging systems with controllable detection view vectors, such as by utilizing aspects of the systems described in U.S. provisional application Ser. No. 62/082,637, filed Nov. 21, 2014, which is hereby incorporated herein by reference in its entirety.

The fluid lens may serve in other automotive applications. For example, when using one or more cameras for supervising or monitoring the driver's head position and eye position and gaze (such as by utilizing aspects of the systems described in U.S. provisional application Ser. No. 61/989,733, filed May 7, 2014, which is hereby incorporated herein by reference in its entirety), the tilt ability of a fluid lens will improve the resolution by which the driver's eye can be monitored. The systems may have a comparably small opening angle (such as, for example, about 10 degrees or thereabouts). The camera's viewing direction may follow the driver's eye(s) position simultaneously with the driver's head movements. Systems without tilt capability have had to have the whole ‘head box’ (in which the system is required to function) in the field of view (FOV) of the fixed (viewing direction) camera. Thus, in prior driver monitoring systems, the camera angle had to be chosen much wider (such as, for example, about 40 or more). For having the same amount of pixels per angle, the imager has to have 16 times higher resolution (for example, a 2 MP imager having a 10 degree lens is comparable in angle resolution to a 32 MP imager having a 40 degree lens). Typically, for automotive applications, the imager is a 2 MP or less imager.

As another application, the adjustable view by using liquid lenses may find use in side—rearview camera applications (such as replacing the vehicle side mirror with one or more cameras, optionally with blind spot monitoring), such as by utilizing aspects of the systems described in PCT Application No. PCT/US2014/042229, filed Jun. 13, 2014 (Attorney Docket MAG04 FP-2334(PCT)), and/or U.S. provisional application Ser. No. 62/082,636, filed Nov. 21, 2014, which are hereby incorporated herein by reference in their entireties, when combining these with surround view vision systems. The liquid optic and lens and thus the camera's field of view may be tilted or aimed generally rearward and sideward and toward the blind spot (to encompass the blind spot region sideward and rearward of the vehicle) when supporting the exceptional view or blind spot monitoring view, and may be tilted generally rearward when supporting driving normal and supporting the normal rearview or panorama view, and may be tilted individually, sidewardly and/or downwardly (to encompass a ground area at or near the side of the vehicle at which the camera is mounted), when backing up or parking, such as under use of a surround vision view or top view vision system. Thus, the control may adjust the lens and camera's field of view responsive to a vehicle input, such as an input indicative of the driving condition of the vehicle, such as forward travel along a road (where image processing of captured image data may be used for rearward viewing or for a blind spot detection system of the vehicle or the like), or a reversing maneuver or a parking maneuver or the like (where image processing of captured image data may be used for a surround view vision system or display system or the like).

As another benefit of the present invention, the fluid lens can be used for image stabilization such as by utilizing aspects of the lens available from Varioptic of Lyon, France.

Thus, the present invention provides a vehicle vision system with one or more cameras that have fluid or liquid lenses, which allow for enhanced focus and tilt and control capability of the camera or cameras and of the vision system. The liquid lens optics may be controlled or adjusted to provide the desired wide angle or narrow angle viewing by the camera and may be used to determine distance to objects present in the field of view of the camera and may be controlled or adjusted to provide a desired field of view of the camera.

Thus, the present invention provides control or adjustment of a liquid lens of one or more cameras of a vehicle, so as to provide different focal lengths or different fields of view or different wide/narrow angle viewing, depending on the particular application of the camera or cameras. For example, the control of the vision system may adjust the liquid optic of a camera responsive to detection or movement of an object in the field of view of the camera, whereby the field of view of the camera may be adjusted to encompass the detected object (such as an object interior or exterior of vehicle). For example, the control may adjust the liquid optic of an interior camera to track and follow and focus on the driver's eyes, whereby image processing of image data captured by such a camera may be used for a driver monitoring system of the vehicle. Optionally, the control may adjust the liquid optic of an exterior camera to track and follow and focus on an object detected exterior of the vehicle (such as during a reversing maneuver of the vehicle or the like), whereby image processing of image data captured by such a camera may be used for an object detection system or backup assist system of the vehicle. Optionally, the control of the vision system may adjust the liquid optic of a camera responsive to a vehicle input or driving condition of the vehicle, whereby a principal axis of the field of view of the camera may be adjusted towards a desired or targeted region (such as sideward of the vehicle or rearward of the vehicle) depending on the driving condition (such as driving forwardly along a road or such as a reversing maneuver or a parking maneuver of the vehicle).

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an EyeQ2 or EyeQ3 image processing chip available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or International Publication Nos. WO 2011/028686; WO 2010/099416; WO 2012/061567; WO 2012/068331; WO 2012/075250; WO 2012/103193; WO 2012/0116043; WO 2012/0145313; WO 2012/0145501; WO 2012/145818; WO 2012/145822; WO 2012/158167; WO 2012/075250; WO 2012/0116043; WO 2012/0145501; WO 2012/154919; WO 2013/019707; WO 2013/016409; WO 2013/019795; WO 2013/067083; WO 2013/070539; WO 2013/043661; WO 2013/048994; WO 2013/063014, WO 2013/081984; WO 2013/081985; WO 2013/074604; WO 2013/086249; WO 2013/103548; WO 2013/109869; WO 2013/123161; WO 2013/126715; WO 2013/043661 and/or WO 2013/158592 and/or PCT Application No. PCT/US2014/042229, filed Jun. 13, 2014 (Attorney Docket MAG04 FP-2334 (PCT)), and/or U.S. patent application Ser. No. 14/524,203, filed Oct. 27, 2014 (Attorney Docket MAG04 P-2409); Ser. No. 14/519,469, filed Oct. 21, 2014 (Attorney Docket MAG04 P-2390); Ser. No. 14/391,841, filed Oct. 10, 2014 (Attorney Docket MAG04 P-2047); Ser. No. 14/489,659, filed Sep. 18, 2014 (Attorney Docket MAG04 P-2374); Ser. No. 14/446,099, filed Aug. 22, 2014 (Attorney Docket MAG04 P-2358); Ser. No. 14/377,940, filed Aug. 11, 2014 (Attorney Docket MAG04 P-2014); Ser. No. 14/377,939, filed Aug. 11, 2014 (Attorney Docket MAG04 P-2010); Ser. No. 14/456,164, filed Aug. 11, 2014 (Attorney Docket MAG04 P-2352); Ser. No. 14/456,163, filed Aug. 11, 2014 (Attorney Docket MAG04 P-2351); Ser. No. 14/456,162, filed Aug. 11, 2014 (Attorney Docket MAG04 P-2350); Ser. No. 14/373,501, filed Jul. 21, 2014 (Attorney Docket MAG04 P-2326); Ser. No. 14/372,524, filed Jul. 16, 2014 (Attorney Docket MAG04 P-1997); Ser. No. 14/324,696, filed Jul. 7, 2014 (Attorney Docket MAG04 P-2324); Ser. No. 14/369,229, filed Jun. 27, 2014 (Attorney Docket MAG04 P-1982); Ser. No. 14/316,940, filed Jun. 27, 2014 (Attorney Docket MAG04 P-2319); Ser. No. 14/316,939, filed Jun. 27, 2014 (Attorney Docket MAG04 P-2317); Ser. No. 14/303,696, filed Jun. 13, 2014 (Attorney Docket MAG04 P-2314); Ser. No. 14/303,695, filed Jun. 13, 2014 (Attorney Docket MAG04 P-2312); Ser. No. 14/303,694, filed Jun. 13, 2014 (Attorney Docket MAG04 P-2303); Ser. No. 14/303,693, filed Jun. 13, 2014 (Attorney Docket MAG04 P-2302); Ser. No. 14/297,663, filed Jun. 6, 2014 (Attorney Docket MAG04 P-2301); Ser. No. 14/362,636, filed Jun. 4, 2014 (Attorney Docket MAG04 P-1967); Ser. No. 14/290,028, filed May 29, 2014 (Attorney Docket MAG04 P-2294); Ser. No. 14/290,026, filed May 29, 2014 (Attorney Docket MAG04 P-2293); Ser. No. 14/359,341, filed May 20, 2014 (Attorney Docket MAG04 P-1961); Ser. No. 14/359,340, filed May 20, 2014 (Attorney Docket MAG04 P-1961); Ser. No. 14/282,029, filed May 20, 02014 (Attorney Docket MAG04 P-2287); Ser. No. 14/282,028, filed May 20, 2014 (Attorney Docket MAG04 P-2286); Ser. No. 14/358,232, filed May 15, 2014 (Attorney Docket MAG04 P-1959); Ser. No. 14/272,834, filed May 8, 2014 (Attorney Docket MAG04 P-2278); Ser. No. 14/356,330, filed May 5, 2014 (Attorney Docket MAG04 P-1954); Ser. No. 14/269,788, filed May 5, 2014 (Attorney Docket MAG04 P-2276); Ser. No. 14/268,169, filed May 2, 2014 (Attorney Docket MAG04 P-2273); Ser. No. 14/264,443, filed Apr. 29, 2014 (Attorney Docket MAG04 P-2270); Ser. No. 14/354,675, filed Apr. 28, 2014 (Attorney Docket MAG04 P-1953); Ser. No. 14/248,602, filed Apr. 9, 2014 (Attorney Docket MAG04 P-2257); Ser. No. 14/242,038, filed Apr. 1, 2014 (Attorney Docket MAG04 P-2255); Ser. No. 14/229,061, filed Mar. 28, 2014 (Attorney Docket MAG04 P-2246); Ser. No. 14/343,937, filed Mar. 10, 2014 (Attorney Docket MAG04 P-1942); Ser. No. 14/343,936, filed Mar. 10, 2014 (Attorney Docket MAG04 P-1937); Ser. No. 14/195,135, filed Mar. 3, 2014 (Attorney Docket MAG04 P-2237); Ser. No. 14/195,136, filed Mar. 3, 2014 (Attorney Docket MAG04 P-2238); Ser. No. 14/191,512, filed Feb. 27, 2014 (Attorney Docket No. MAG04 P-2228); Ser. No. 14/183,613, filed Feb. 19, 2014 (Attorney Docket No. MAG04 P-2225); Ser. No. 14/169,329, filed Jan. 31, 2014 (Attorney Docket MAG04 P-2218); Ser. No. 14/169,328, filed Jan. 31, 2014 (Attorney Docket MAG04 P-2217); Ser. No. 14/163,325, filed Jan. 24, 2014 (Attorney Docket No. MAG04 P-2216); Ser. No. 14/159,772, filed Jan. 21, 2014 (Attorney Docket MAG04 P-2215); Ser. No. 14/107,624, filed Dec. 16, 2013 (Attorney Docket MAG04 P-2206); Ser. No. 14/102,981, filed Dec. 11, 2013 (Attorney Docket MAG04 P-2196); Ser. No. 14/102,980, filed Dec. 11, 2013 (Attorney Docket MAG04 P-2195); Ser. No. 14/098,817, filed Dec. 6, 2013 (Attorney Docket MAG04 P-2193); Ser. No. 14/097,581, filed Dec. 5, 2013 (Attorney Docket MAG04 P-2192); Ser. No. 14/093,981, filed Dec. 2, 2013 (Attorney Docket MAG04 P-2197); Ser. No. 14/093,980, filed Dec. 2, 2013 (Attorney Docket MAG04 P-2191); Ser. No. 14/082,573, filed Nov. 18, 2013 (Attorney Docket MAG04 P-2183); Ser. No. 14/082,574, filed Nov. 18, 2013 (Attorney Docket MAG04 P-2184); Ser. No. 14/082,575, filed Nov. 18, 2013 (Attorney Docket MAG04 P-2185); Ser. No. 14/082,577, filed Nov. 18, 2013 (Attorney Docket MAG04 P-2203); Ser. No. 14/071,086, filed Nov. 4, 2013 (Attorney Docket MAG04 P-2208); Ser. No. 14/076,524, filed Nov. 11, 2013 (Attorney Docket MAG04 P-2209); Ser. No. 14/052,945, filed Oct. 14, 2013 (Attorney Docket MAG04 P-2165); Ser. No. 14/046,174, filed Oct. 4, 2013 (Attorney Docket MAG04 P-2158); Ser. No. 14/016,790, filed Oct. 3, 2013 (Attorney Docket MAG04 P-2139); Ser. No. 14/036,723, filed Sep. 25, 2013 (Attorney Docket MAG04 P-2148); Ser. No. 14/016,790, filed Sep. 3, 2013 (Attorney Docket MAG04 P-2139); Ser. No. 14/001,272, filed Aug. 23, 2013 (Attorney Docket MAG04 P-1824); Ser. No. 13/970,868, filed Aug. 20, 2013 (Attorney Docket MAG04 P-2131); Ser. No. 13/964,134, filed Aug. 12, 2013 (Attorney Docket MAG04 P-2123); Ser. No. 13/942,758, filed Jul. 16, 2013 (Attorney Docket MAG04 P-2127); Ser. No. 13/942,753, filed Jul. 16, 2013 (Attorney Docket MAG04 P-2112); Ser. No. 13/927,680, filed Jun. 26, 2013 (Attorney Docket MAG04 P-2091); Ser. No. 13/916,051, filed Jun. 12, 2013 (Attorney Docket MAG04 P-2081); Ser. No. 13/894,870, filed May 15, 2013 (Attorney Docket MAG04 P-2062); Ser. No. 13/887,724, filed May 6, 2013 (Attorney Docket MAG04 P-2072); Ser. No. 13/852,190, filed Mar. 28, 2013 (Attorney Docket MAG04 P-2046); Ser. No. 13/851,378, filed Mar. 27, 2013 (Attorney Docket MAG04 P-2036); Ser. No. 13/848,796, filed Mar. 22, 2012 (Attorney Docket MAG04 P-2034); Ser. No. 13/847,815, filed Mar. 20, 2013 (Attorney Docket MAG04 P-2030); Ser. No. 13/800,697, filed Mar. 13, 2013 (Attorney Docket MAG04 P-2060); Ser. No. 13/785,099, filed Mar. 5, 2013 (Attorney Docket MAG04 P-2017); Ser. No. 13/779,881, filed Feb. 28, 2013 (Attorney Docket MAG04 P-2028); Ser. No. 13/774,317, filed Feb. 22, 2013 (Attorney Docket MAG04 P-2015); Ser. No. 13/774,315, filed Feb. 22, 2013 (Attorney Docket MAG04 P-2013); Ser. No. 13/681,963, filed Nov. 20, 2012 (Attorney Docket MAG04 P-1983); Ser. No. 13/660,306, filed Oct. 25, 2012 (Attorney Docket MAG04 P-1950); Ser. No. 13/653,577, filed Oct. 17, 2012 (Attorney Docket MAG04 P-1948); and/or Ser. No. 13/534,657, filed Jun. 27, 2012 (Attorney Docket MAG04 P-1892), which are all hereby incorporated herein by reference in their entireties. The system may communicate with other communication systems via any suitable means, such as by utilizing aspects of the systems described in International Publication Nos. WO/2010/144900; WO 2013/043661 and/or WO 2013/081985, and/or U.S. patent application Ser. No. 13/202,005, filed Aug. 17, 2011 (Attorney Docket MAG04 P-1595), which are hereby incorporated herein by reference in their entireties.

The imaging device and control and image processor and any associated illumination source, if applicable, may comprise any suitable components, and may utilize aspects of the cameras and vision systems described in U.S. Pat. Nos. 5,550,677; 5,877,897; 6,498,620; 5,670,935; 5,796,094; 6,396,397; 6,806,452; 6,690,268; 7,005,974; 7,937,667; 7,123,168; 7,004,606; 6,946,978; 7,038,577; 6,353,392; 6,320,176; 6,313,454 and/or 6,824,281, and/or International Publication Nos. WO 2010/099416; WO 2011/028686 and/or WO 2013/016409, and/or U.S. Pat. Publication No. US 2010-0020170, and/or U.S. patent application Ser. No. 13/534,657, filed Jun. 27, 2012 (Attorney Docket MAG04 P-1892), which are all hereby incorporated herein by reference in their entireties. The camera or cameras may comprise any suitable cameras or imaging sensors or camera modules, and may utilize aspects of the cameras or sensors described in U.S. Publication No. US-2009-0244361 and/or U.S. Pat. Nos. 8,542,451; 7,965,336 and/or 7,480,149, which are hereby incorporated herein by reference in their entireties. The imaging array sensor may comprise any suitable sensor, and may utilize various imaging sensors or imaging array sensors or cameras or the like, such as a CMOS imaging array sensor, a CCD sensor or other sensors or the like, such as the types described in U.S. Pat. Nos. 5,550,677; 5,670,935; 5,760,962; 5,715,093; 5,877,897; 6,922,292; 6,757,109; 6,717,610; 6,590,719; 6,201,642; 6,498,620; 5,796,094; 6,097,023; 6,320,176; 6,559,435; 6,831,261; 6,806,452; 6,396,397; 6,822,563; 6,946,978; 7,339,149; 7,038,577; 7,004,606; 7,720,580 and/or 7,965,336, and/or International Publication Nos. WO/2009/036176 and/or WO/2009/046268, which are all hereby incorporated herein by reference in their entireties.

The camera module and circuit chip or board and imaging sensor may be implemented and operated in connection with various vehicular vision-based systems, and/or may be operable utilizing the principles of such other vehicular systems, such as a vehicle headlamp control system, such as the type disclosed in U.S. Pat. Nos. 5,796,094; 6,097,023; 6,320,176; 6,559,435; 6,831,261; 7,004,606; 7,339,149 and/or 7,526,103, which are all hereby incorporated herein by reference in their entireties, a rain sensor, such as the types disclosed in commonly assigned U.S. Pat. Nos. 6,353,392; 6,313,454; 6,320,176 and/or 7,480,149, which are hereby incorporated herein by reference in their entireties, a vehicle vision system, such as a forwardly, sidewardly or rearwardly directed vehicle vision system utilizing principles disclosed in U.S. Pat. Nos. 5,550,677; 5,670,935; 5,760,962; 5,877,897; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978 and/or 7,859,565, which are all hereby incorporated herein by reference in their entireties, a trailer hitching aid or tow check system, such as the type disclosed in U.S. Pat. No. 7,005,974, which is hereby incorporated herein by reference in its entirety, a reverse or sideward imaging system, such as for a lane change assistance system or lane departure warning system or for a blind spot or object detection system, such as imaging or detection systems of the types disclosed in U.S. Pat. Nos. 7,881,496; 7,720,580; 7,038,577; 5,929,786 and/or 5,786,772, which are hereby incorporated herein by reference in their entireties, a video device for internal cabin surveillance and/or video telephone function, such as disclosed in U.S. Pat. Nos. 5,760,962; 5,877,897; 6,690,268 and/or 7,370,983, and/or U.S. Publication No. US-2006-0050018, which are hereby incorporated herein by reference in their entireties, a traffic sign recognition system, a system for determining a distance to a leading or trailing vehicle or object, such as a system utilizing the principles disclosed in U.S. Pat. Nos. 6,396,397 and/or 7,123,168, which are hereby incorporated herein by reference in their entireties, and/or the like.

Optionally, the circuit board or chip may include circuitry for the imaging array sensor and or other electronic accessories or features, such as by utilizing compass-on-a-chip or EC driver-on-a-chip technology and aspects such as described in U.S. Pat. Nos. 7,255,451 and/or 7,480,149 and/or U.S. Publication No. US-2006-0061008 and/or U.S. patent application Ser. No. 12/578,732, filed Oct. 14, 2009 (Attorney Docket DON01 P-1564), which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device disposed at or in the interior rearview mirror assembly of the vehicle, such as by utilizing aspects of the video mirror display systems described in U.S. Pat. No. 6,690,268 and/or U.S. patent application Ser. No. 13/333,337, filed Dec. 21, 2011 (Attorney Docket DON01 P-1797), which are hereby incorporated herein by reference in their entireties. The video mirror display may comprise any suitable devices and systems and optionally may utilize aspects of the compass display systems described in U.S. Pat. Nos. 7,370,983; 7,329,013; 7,308,341; 7,289,037; 7,249,860; 7,004,593; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; 6,513,252 and/or 6,642,851, and/or European patent application, published Oct. 11, 2000 under Publication No. EP 0 1043566, and/or U.S. Publication No. US-2006-0061008, which are all hereby incorporated herein by reference in their entireties. Optionally, the video mirror display screen or device may be operable to display images captured by a rearward viewing camera of the vehicle during a reversing maneuver of the vehicle (such as responsive to the vehicle gear actuator being placed in a reverse gear position or the like) to assist the driver in backing up the vehicle, and optionally may be operable to display the compass heading or directional heading character or icon when the vehicle is not undertaking a reversing maneuver, such as when the vehicle is being driven in a forward direction along a road (such as by utilizing aspects of the display system described in International Publication No. WO 2012/051500, which is hereby incorporated herein by reference in its entirety).

Optionally, the vision system (utilizing the forward facing camera and a rearward facing camera and other cameras disposed at the vehicle with exterior fields of view) may be part of or may provide a display of a top-down view or birds-eye view system of the vehicle or a surround view at the vehicle, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249 and/or WO 2013/109869, and/or U.S. patent application Ser. No. 13/333,337, filed Dec. 21, 2011 (Attorney Docket DON01 P-1797), which are hereby incorporated herein by reference in their entireties.

Optionally, a video mirror display may be disposed rearward of and behind the reflective element assembly and may comprise a display such as the types disclosed in U.S. Pat. Nos. 5,530,240; 6,329,925; 7,855,755; 7,626,749; 7,581,859; 7,446,650; 7,370,983; 7,338,177; 7,274,501; 7,255,451; 7,195,381; 7,184,190; 5,668,663; 5,724,187 and/or 6,690,268, and/or in U.S. Publication Nos. US-2006-0061008 and/or US-2006-0050018, which are all hereby incorporated herein by reference in their entireties. The display is viewable through the reflective element when the display is activated to display information. The display element may be any type of display element, such as a vacuum fluorescent (VF) display element, a light emitting diode (LED) display element, such as an organic light emitting diode (OLED) or an inorganic light emitting diode, an electroluminescent (EL) display element, a liquid crystal display (LCD) element, a video screen display element or backlit thin film transistor (TFT) display element or the like, and may be operable to display various information (as discrete characters, icons or the like, or in a multi-pixel manner) to the driver of the vehicle, such as passenger side inflatable restraint (PSIR) information, tire pressure status, and/or the like. The mirror assembly and/or display may utilize aspects described in U.S. Pat. Nos. 7,184,190; 7,255,451; 7,446,924 and/or 7,338,177, which are all hereby incorporated herein by reference in their entireties. The thicknesses and materials of the coatings on the substrates of the reflective element may be selected to provide a desired color or tint to the mirror reflective element, such as a blue colored reflector, such as is known in the art and such as described in U.S. Pat. Nos. 5,910,854; 6,420,036 and/or 7,274,501, which are hereby incorporated herein by reference in their entireties.

Optionally, the display or displays and any associated user inputs may be associated with various accessories or systems, such as, for example, a tire pressure monitoring system or a passenger air bag status or a garage door opening system or a telematics system or any other accessory or system of the mirror assembly or of the vehicle or of an accessory module or console of the vehicle, such as an accessory module or console of the types described in U.S. Pat. Nos. 7,289,037; 6,877,888; 6,824,281; 6,690,268; 6,672,744; 6,386,742 and/or 6,124,886, and/or U.S. Publication No. US-2006-0050018, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vision system of a vehicle, said vision system comprising:
a camera disposed at a vehicle and having a field of view;
wherein said camera comprises an imager and a lens;
wherein said lens comprises a liquid optic;
a control, wherein said control is operable to vary a voltage at said liquid optic to at least one of (i) adjust a tilt of said lens and (ii) adjust a focal length of said lens;
an image processor operable to process image data captured by said camera; and
wherein said control is operable to vary the voltage responsive to one of (i) detection of an object, (ii) movement of an object and (iii) a vehicle input.

2. The vision system of claim 1, wherein said control is operable to apply a variable voltage at said lens to adjust said liquid optic to adjust a tilt of said lens.

3. The vision system of claim 1, wherein said control is operable to apply a variable voltage at said lens to adjust said liquid optic to adjust a focal length of said lens.

4. The vision system of claim 3, wherein said control is operable to determine distance to an object present in the field of view of said camera by adjusting the focal length of said lens.

5. The vision system of claim 1, wherein said camera has a field of view exterior of the vehicle.

6. The vision system of claim 1, wherein said camera has a field of view interior of the vehicle.

7. The vision system of claim 6, wherein said control is operable to adjust said liquid optic responsive to detection and movement of the driver's eyes, and wherein said image processor processes captured image data for a driver monitoring system of the vehicle.

8. The vision system of claim 1, wherein said camera is fixedly disposed at the vehicle and wherein said control is operable to vary the voltage at said lens to adjust said liquid optic to adjust a tilt of said lens to adjust the field of view of said camera.

9. The vision system of claim 1, wherein said control is operable to adjust said liquid optic responsive to detection of an object, and wherein said control adjusts said liquid optic to track a detected object.

10. The vision system of claim 1, wherein said control is operable to adjust said liquid optic responsive to a vehicle input.

11. The vision system of claim 10, wherein said control adjusts said liquid optic to adjust the tilt of said lens and the field of view of said camera responsive to said vehicle input, and wherein said vehicle input is indicative of a driving condition of the vehicle.

12. The vision system of claim 11, wherein said camera is disposed at a side region of the vehicle.

13. The vision system of claim 12, wherein said control, responsive to the vehicle input being indicative of forward driving along a road, adjusts the tilt of said lens so that the field of view of said camera encompasses a blind spot region sideward and rearward of the vehicle, and wherein said image processor processes captured image data for a blind spot detection system of the vehicle.

14. The vision system of claim 12, wherein said control, responsive to the vehicle input being indicative of a reversing maneuver of the vehicle, adjusts the tilt of said lens so that the field of view of said camera encompasses a ground region adjacent to the side of the vehicle, and wherein said image processor processes captured image data for a surround view vision system of the vehicle.

15. A vision system of a vehicle, said vision system comprising:
a camera disposed at a side region of a vehicle and having a field of view exterior of the vehicle;
wherein said camera comprises an imager and a lens;
wherein said lens comprises a liquid optic;
a control, wherein said control is operable to vary a voltage at said liquid optic to selectively (i) adjust a tilt of said lens and (ii) adjust a focal length of said lens;
an image processor operable to process image data captured by said camera; and
wherein said control is operable to vary the voltage responsive to a vehicle input and wherein said vehicle input is indicative of a driving condition of the vehicle.

16. The vision system of claim 15, wherein said control is operable to determine distance to an object present in the field of view of said camera by adjusting the focal length of said lens.

17. The vision system of claim 15, wherein said camera is fixedly disposed at the side region of the vehicle and wherein said control is operable to vary the voltage to adjust the tilt of said lens to adjust the field of view of said camera between a blind spot viewing orientation, where a principal axis of the field of view of said camera is generally rearward, and a surround view display orientation, where a principal axis of the field of view of said camera is generally sideward and downward.

18. The vision system of claim 17, wherein said image processor is operable to (i) process captured image data for a blind spot detection system of the vehicle when said camera is in the blind spot viewing orientation, and (ii) process captured image data for a surround view vision system of the vehicle when said camera is in the surround view display orientation.

19. A vision system of a vehicle, said vision system comprising:
a camera disposed at a side region of a vehicle and having a field of view exterior of the vehicle;
wherein said camera comprises an imager and a lens;
wherein said lens comprises a liquid optic;
a control, wherein said control is operable to vary a voltage at said liquid optic to adjust a tilt of said lens;
wherein said control is operable to vary the voltage responsive to a vehicle input and wherein said vehicle input is indicative of a driving condition of the vehicle;
wherein, responsive to said vehicle input being indicative of forward driving of the vehicle along a road, said control is operable to vary the voltage to adjust the tilt of said lens to adjust the field of view of said camera rearward to a blind spot viewing orientation, where a principal axis of the field of view of said camera is generally rearward;
wherein, responsive to said vehicle input being indicative of a parking maneuver of the vehicle, said control is operable to vary the voltage to adjust the tilt of said lens to adjust the field of view of said camera downward to a surround view display orientation, where a principal axis of the field of view of said camera is generally sideward and downward;
an image processor operable to process image data captured by said camera; and
wherein said image processor is operable to process captured image data for a blind spot detection system of the vehicle when said camera is in the blind spot viewing orientation.

20. The vision system of claim 19, wherein said control is operable to vary the voltage at said liquid optic to adjust a focal length of said lens, and wherein said control is operable to determine distance to an object present in the field of view of said camera by adjusting the focal length of said lens.
